(19) United States
(12) Patent Application Publication
(10) Pub. No.: US 2025/0202182 A1
(43) Pub. Date: Jun. 19, 2025

(54) SYSTEM FOR ATTACHING A CONNECTOR TO A CONDUCTOR

(71) Applicant: Lear Corporation, Southfield, MI (US)

(72) Inventors: Bhupinder Rangi, Novi, MI (US); Lewis Galligan, Novi, MI (US)

(21) Appl. No.: 18/935,008

(22) Filed: Nov. 1, 2024

Related U.S. Application Data
(60) Provisional application No. 63/610,634, filed on Dec. 15, 2023.

(51) Int. Cl. H01R 43/027; H01R 43/26

(52) U.S. Cl. CPC H01R 43/027; H01R 43/26

(57) ABSTRACT

A system for attaching an electrical connector to a conductor may include a header assembly and a terminal. The header assembly may be connectable to said conductor and releasably connectable to said connector. The terminal may be disposed in and connected to the header assembly. The terminal may be connectable to said conductor such that the terminal projects radially from said conductor. When the header assembly is connected to said conductor and to said connector, (i) the header assembly may physically connect said conductor and said connector and (ii) the terminal may engage a connector conductor of said connector electrically connecting said conductor and said connector.

### CROSS-REFERENCE TO RELATED APPLICATION

This application claims priority to U.S. Provisional Patent Application No. 63/610,634, filed on Dec. 15, 2023, the content of which is hereby incorporated by reference in its entirety.

### TECHNICAL FIELD

The present disclosure generally relates to systems for attaching a connector to a conductor, such as an aluminum power conductor, that may, for example, be utilized in connection with and/or incorporated into vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view generally illustrating an embodiment of a system according to teachings of the present disclosure.

FIG. 2 is a perspective view generally illustrating another embodiment of a system according to teachings of the present disclosure.

FIG. 3 is a perspective view generally illustrating an embodiment of a conductor according to teachings of the present disclosure.

FIG. 4 is a perspective view generally illustrating an embodiment of a plurality of terminals connected to a conductor according to teachings of the present disclosure.

FIGS. 5-7 are perspective views generally illustrating an embodiment of a method of attaching a connector to a conductor with the system of FIG. 1 according to teachings of the present disclosure.

FIGS. 8 and 9 are an exploded view and a perspective view, respectively, generally illustrating another embodiment of a terminal according to teachings of the present disclosure.

FIGS. 10 and 11 are perspective views generally illustrating an embodiment of a method of attaching the terminal of FIGS. 8 and 9 to a conductor according to teachings of the present disclosure.

FIGS. 12-15 are perspective views generally illustrating an embodiment of a method of attaching a connector to a conductor with the system of FIG. 2 according to teachings of the present disclosure.

FIG. 16 is a side cross-sectional view generally illustrating the system of FIG. 2 according to teachings of the present disclosure.

FIG. 17 is a side cross-sectional view generally illustrating an embodiment of a system according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

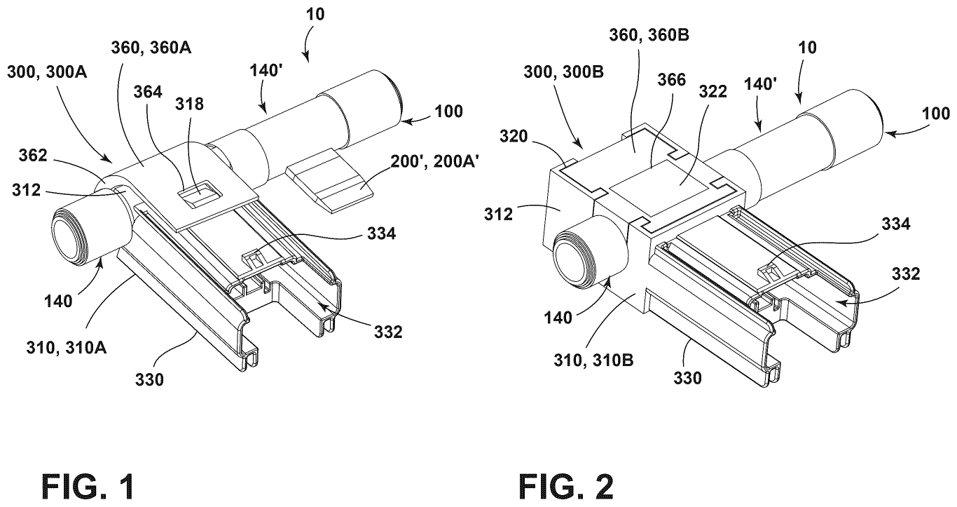

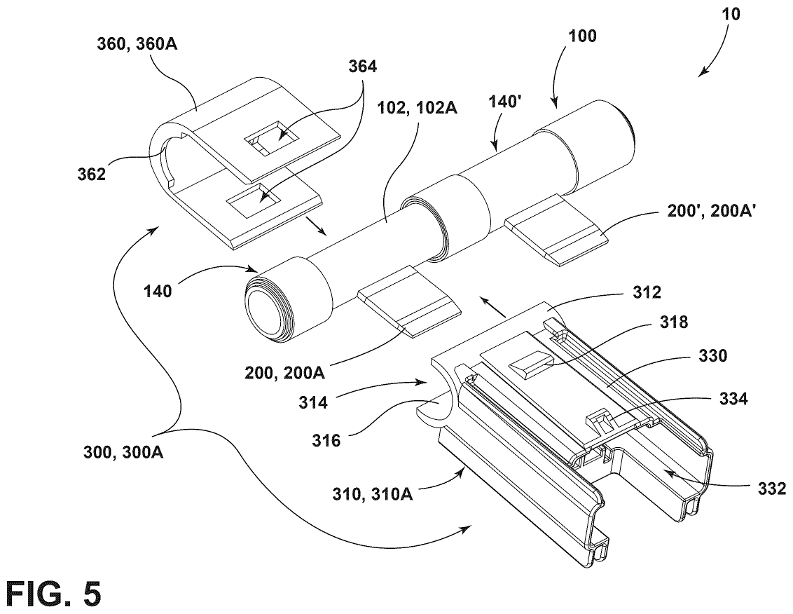

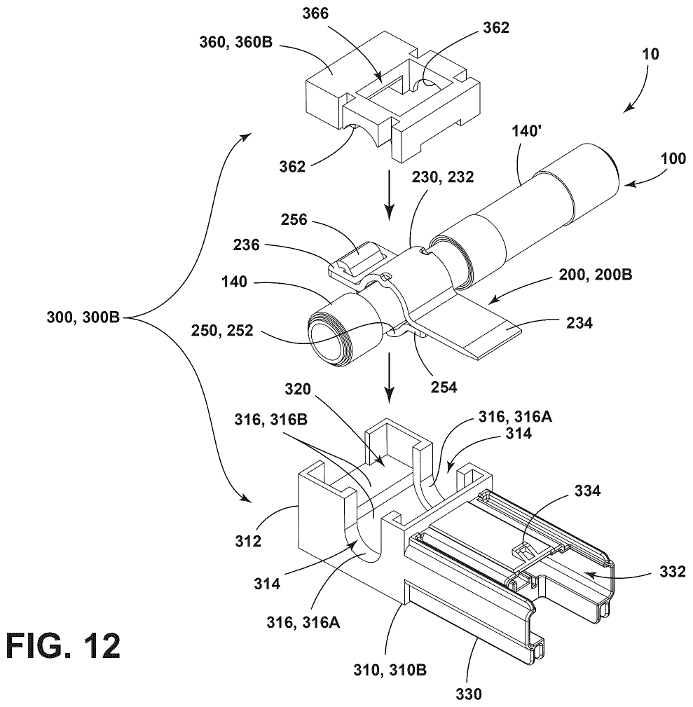

Referring to FIGS. 1 and 2, a system 10 for attaching (e.g., in a non-parallel manner) an electrical connector 20 to a conductor 100 is depicted. The system 10 includes one or more terminals 200 and one or more header assemblies 300 (see, e.g., FIGS. 5 and 12). Optionally, the system 10 may include the conductor 100 and/or the connector 20. The terminal 200 and header assembly 300 are each connected, attached, fixed, and/or mounted to one or more portions of the conductor 100. The header assembly 300 receives and retains at least a portion of the conductor 100 and the terminal 200 (see, e.g., FIGS. 5 and 12). The header assembly 300 engages and releasably connects to the connector 20 thereby securing, attaching, and/or connecting the connector 20 to the conductor 100 (see, e.g., FIGS. 5-7 and 12-15). When the connector 20 is attached to the header assembly 300, the terminal 200 contacts a connector conductor 22 attached to and disposed at least partially within the connector 20 establishing an electrical connection between the conductor 100 and the connector 20.

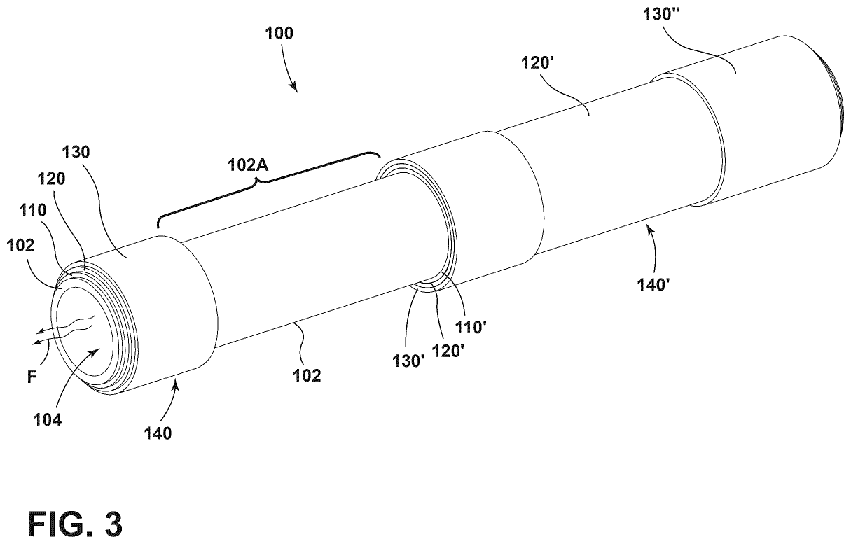

As generally illustrated in FIG. 3, the conductor 100 is a fluid-cooled, aluminum power conductor. Alternatively, the conductor 100 may not be fluid cooled (e.g., may not be a fluid-cooled conductor) and/or may be another type of conductor (e.g., a copper conductor). The conductor 100 includes a conductor body 102, one or more inner insulators 110, 110′ (e.g., XLPE insulators), one or more shields 120, 120′, one or more outer insulators 130, 130′, 130″, and/or one or more protectors 140, 140′.

As generally illustrated in FIG. 3, the conductor 100 includes a conductor body 102. The conductor body 102 is an elongated hollow and/or tubular aluminum body that conducts a fluid F (e.g., a cooling liquid) to, for example, cool the conductor 100 and/or one or more components connected thereto. The conductor body 102 defines a fluid channel 104 through which the fluid F is flowable. Alternatively, the conductor body 102 may be a solid aluminum body (e.g., a solid aluminum core) that does not conduct a fluid and does not define a fluid channel 104. The conductor body 102 and the fluid channel 104 generally have a round cross-sectional shape (e.g., in a radially extending plane), but may have other cross-sectional shapes in other embodiments. The conductor body 102 includes an exposed region 102A, section, and/or portion that is not covered by an inner insulator 110, 110′, a shield 120, 120′, nor an outer insulator 130, 130′, 130″. The exposed region 102A of the conductor body 102 is a longitudinal region, section, and/or portion of the conductor body 102 disposed between a first protector 140 (e.g., a first inner insulator 110, a first shield 120, and/or a first outer insulator 130) and a second protector 140′ (e.g., a second inner insulator 110′, a second shield 120′, a second outer insulator 130′, and/or a third outer insulator 130″). Alternatively, the exposed region 102A may have one or more configurations in other embodiments. For example, the exposed region 102A may be a region, section, and/or portion of the conductor body 102 that is exposed and/or accessible via one or more recesses (e.g., windows) disposed in and/or defined by one or more protectors 140, 140′, inner insulators 110, 110′, shields 120, 120′, and/or outer insulators 130, 130′, 130″.

As generally illustrated in FIG. 3, the conductor 100 includes one or more inner insulators 110, 110′ (e.g., a first inner insulator 110 and a second inner insulator 110′) that protect and/or electrically insulate one or more portions, sections, and/or regions of the conductor body 102. The inner insulators 110, 110′ are composed of and/or include a polymer, such as cross-linked polyethylene (XLPE), but may be composed of and/or include one or more other suitable materials in other embodiments. The inner insulators 110, 110′ are disposed on and connected to the conductor body 102 (e.g., an outer circumferential surface of the conductor body 102). The inner insulators 110, 110′ extend circumferentially around the conductor body 102 and extend longitudinally along at least a portion, section, and/or region of the conductor body 102. The inner insulators 110, 110′ each have a tubular shape and each circumferentially surround (e.g., completely) at least a longitudinal portion, section, and/or region of the conductor body 102.

As generally illustrated in FIG. 3, the conductor 100 includes one or more shields 120, 120′ (e.g., a first shield 120 and a second shield 120′) that protect one or more portions, sections, and/or regions of the conductor body 102 and/or of one or more inner insulators 110, 110′ from, for example, electrostatic interference, electromagnetic interference, and/or electrical field interference. The shields 120, 120′ are each configured as a braided sleeve (e.g., a metallic braided sleeve and/or a non-metallic braided sleeve) and are composed of and/or include aluminum, but may have one or more other suitable configurations in other embodiments. The shields 120, 120′ are disposed on and connected to one or more inner insulators 110, 110′ (e.g., an outer circumferential surface of one or more inner insulators 110, 110′), which may connect the shields 120, 120′ to the conductor body 102. The shields 120, 120′ extend circumferentially around the conductor body 102 and one or more inner insulators 110, 110′, and extend longitudinally along at least a portion, section, and/or region of the conductor body 102 and/or at least a portion, section, and/or region of one or more inner insulators 110, 110′.

As generally illustrated in FIG. 3, the conductor 100 includes one or more outer insulators 130, 130′, 130″ (e.g., a first outer insulator 130, a second outer insulator 130′, and a third outer insulator 130″) that protect and/or electrically insulate one or more portions, sections, and/or regions of the conductor body 102, of one or more inner insulators 110, 110′, and/or of one or more shields 120, 120′. The outer insulators 130, 130′, 130″ are composed of and/or include a polymer, but may be composed of and/or include one or more other suitable materials in other embodiments. The outer insulators 130, 130′, 130″ are disposed on and connected to one or more shields 120, 120′ (e.g., an outer circumferential surface of one or more shields 120, 120′), which may connect the outer insulators 130, 130′, 130″ to the conductor body 102. The outer insulators 130, 130′, 130″ extend circumferentially around the conductor body 102, one or more inner insulators 110, 110′, and/or one or more shields 120, 120′. The outer insulators 130, 130′, 130″ extend longitudinally along at least a portion, section, and/or region of the conductor body 102, at least a portion, section, and/or region of one or more inner insulators 110, 110′, and/or at least a portion, section, and/or region of one or more shields 120, 120′. One or more of the outer insulators 130, 130′, 130″ may be configured as a collar and/or may be disposed at or about a longitudinal end of one or more shields 120, 120′.

As generally illustrated in FIG. 3, the conductor 100 includes one or more protectors 140, 140′ (e.g., a first protector 140 and a second protector 140′). Each protector 140, 140′ is defined by and/or includes one or more inner insulators 110, 110′, one or more shields 120, 120′, and/or one or more outer insulators 130, 130′, 130″. The first protector 140, 140′ is defined by and/or includes the first inner insulator 110, the first shield 120, and the first outer insulator 130. The second protector 140′ is defined by and/or includes the second inner insulator 110′, the second shield 120′, the second outer insulator 130′, and the third outer insulator 130″. The first protector 140 and the second protector 140′ are disposed on the conductor body 102 spaced apart from one another in a longitudinal direction of the conductor body 102 such that a portion, section, and/or region of the conductor body 102 (e.g., the exposed region 102A) is exposed and/or is not covered by the protectors 140, 140′.

As generally illustrated in FIG. 3, the first inner insulator 110 and the second inner insulator 110′ are disposed spaced apart from one another in a longitudinal direction of the conductor body 102 such that a region, section, and/or portion of the conductor body 102 (e.g., the exposed region 102A) is exposed and/or is not covered by the inner insulators 110, 110′. The first shield 120 is disposed on and connected to the first inner insulator 110 (e.g., an outer circumferential surface of the first inner insulator 110). The first shield 120 is disposed adjacent to the exposed region 102A of the conductor body 102. An end of the first shield 120 is disposed at or about (e.g., aligned with) an end of the first inner insulator 110 that is disposed adjacent to and/or boarders the exposed region 102A of the conductor body 102. The first outer insulator 130 is disposed on and connected to the first shield 120 (e.g., an outer circumferential surface of the first shield 120). The first outer insulator 130 is disposed adjacent to the exposed region 102A of the conductor body 102. An end of the first outer insulator 130 is disposed at or about (e.g., aligned with) the end of the first inner insulator 110 and/or the end of the first shield 120. The first inner insulator 110, the first shield 120, and the first outer insulator 130 define and/or form the first protector 140. The second shield 120′ is disposed on and connected to the second inner insulator 110′ (e.g., an outer circumferential surface of the second inner insulator 110′). The second shield 120′ is disposed adjacent to the exposed region 102A of the conductor body 102. An end of the second shield 120′ is disposed at or about (e.g., aligned with) an end of the second inner insulator 110′ that is disposed adjacent to and/or boarders the exposed region 102A of the conductor body 102. The second outer insulator 130′ and the third outer insulator 130″ are disposed on and connected to the second shield 120′ (e.g., an outer circumferential surface of the second shield 120′). The second outer insulator 130′ and the third outer insulator 130″ are disposed on the second shield 120′ spaced apart from one another in a longitudinal direction of the conductor body 102 and/or a longitudinal direction of the second shield 120′. The second outer insulator 130′ is disposed adjacent to the exposed region 102A of the conductor body 102. An end of the second outer insulator 130′ is disposed at or about (e.g., aligned with) the end of the second inner insulator 110′ and/or the end of the second shield 120′. The second inner insulator 110′, the second shield 120′, the second outer insulator 130′, and the third outer insulator 130″ define and/or form the second protector 140′.

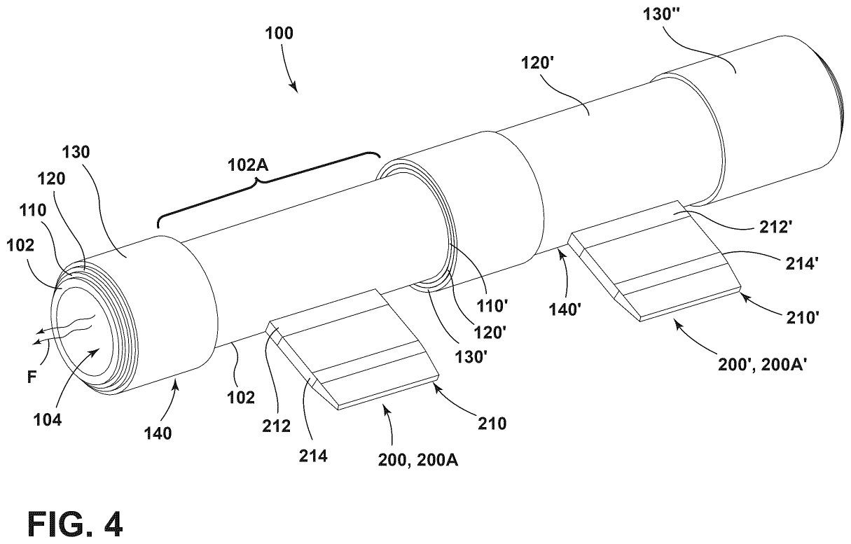

As generally illustrated in FIGS. 4, 5, and 8-11, the system 10 includes one or more terminals 200, 200′ configured to electrically connect the conductor 100 and the connector 20. One or more terminals 200 (e.g., first/conductor body terminals 200A, 200B) is disposed on and connected (e.g., physically and electrically) to the exposed region 102A of the conductor body 102. Optionally, embodiments of the system 10 may also include one or more terminals 200 (e.g., second/shield terminals 200′) disposed on and connected (e.g., physically and electrically) to one or more shields 120, 120′ (e.g., the second shield 120′) as illustrated in FIGS. 4 and 5. One or more terminals 200 may be configured substantially similar to and/or differently than one or more other terminals 200. The one or more terminals 200 and/or at least a portion thereof (e.g., blade 210, 234) projects and/or extends transversely (e.g., perpendicularly or obliquely) and/or substantially radially from the conductor 100.

With embodiments, such as those generally illustrated in FIG. 4, one or more terminals 200A is configured as an elongated body composed of and/or including one or more materials. For example, the elongated body may be a blade 210 composed of and/or including two different metals (e.g., a bi-metal blade). The blade 210 extends transversely (e.g., perpendicularly or obliquely) relative to the conductor 100 and projects transversely and/or radially from the conductor 100. The blade 210 includes a first portion 212 and a second portion 214. The first and second portions 212, 214 may be separate bodies that are connected to one another to form the blade 210 and/or the terminal 200A. Alternatively, the first and second portions 212, 214 may be regions and/or sections of a monolithic body that defines the blade 210 and/or the terminal 200A. The first portion 212 is composed of and/or includes aluminum. The first portion 212 is connected (e.g., laser welded and/or via a laser weld) to the conductor 100, such as to the exposed region 102A of the conductor body 102. An end of the first portion 212 opposite the conductor 100 is connected to the second portion 214 of the blade 210. The second portion 214 is composed of and/or includes copper. The second portion 214 forms and/or defines a free end of the blade 210 and is configured to engage and/or contact the connector conductor 22 to electrically connect the conductor 100 and the connector 20. A free end of the blade 210 and/or the second portion 214 is tapered to facilitate insertion into the connector 20 during engagement of the header assembly 300 and the connector 20. The second terminal 200′, 200A′ includes a blade 210′, a first portion 212′, and a second portion 214′ that are configured substantially similar to the corresponding features of the first terminal 200A. The first portion 212′ of the second terminal 200′ is connected (e.g., laser welded and/or via a laser weld) to the second shield 120′.

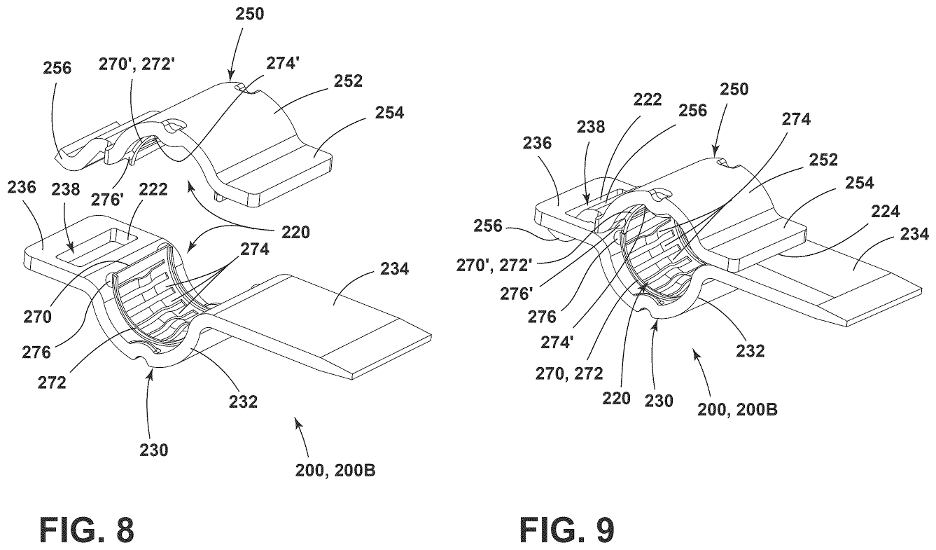

With embodiments, such as those generally illustrated in FIGS. 8 and 9, the terminal 200B includes a receptacle 220, a base 230, a cover 250, one or more biasing bodies 270, 270′, and one or more connections 222, 224. The base 230, the cover 250, and the biasing bodies 270, 270′ are composed of and/or include copper, but may be composed of and/or include one or more other suitable materials. The base 230 and the cover 250 are disposed on and connected to one another via the one or more connections (e.g., a first connection 222, a second connection 224). The receptacle 220 is defined by and between one or more portions of the base 230 (e.g., the U-shaped body 232) and one or more portions of the cover 250 (e.g., the U-shaped body 252). The receptacle 220 is configured to receive and/or retain at least a portion of the conductor 100 (e.g., the exposed region 102A of the conductor body 102).

As generally illustrated in FIGS. 8 and 9, the base 230 includes a generally U-shaped body 232, a blade 234, and a protrusion 236. The blade 234 and the protrusion 236 are connected to and project from opposite sides/ends of the U-shaped body 232 in opposite directions (e.g., generally radially relative to a longitudinal axis of the receptacle 220 and/or the conductor 100). The protrusion 236 includes and/or defines a recess 238 configured to engage and/or receive a portion of the cover 250 (e.g., the flange 256). The blade 234 extends and/or protrudes transversely (e.g., perpendicularly or obliquely) and/or radially relative to the conductor 100. A free end of the blade 234 is tapered to facilitate insertion into the connector 20 during engagement of the header assembly 300 and the connector 20.

As generally illustrated in FIGS. 8 and 9, the cover 250 includes a generally U-shaped body 252, a projection 254, and a flange 256. The projection 254 and the flange 256 are connected to and project from opposite sides/ends of the U-shaped body 252 in opposite directions (e.g., generally radially relative to the longitudinal axis of the receptacle 220). The flange 256 is curved and/or generally S-shaped (e.g., defines an S-shape in a radially extending plane perpendicular to a longitudinal axis of the receptacle 220 and/or the conductor 100). A width of the flange 256 (e.g., in the longitudinal direction of the receptacle 220 and/or the conductor 100) is equal to and/or smaller than a width of the U-shaped body 252 of the cover 250 and a width of the protrusion 236 of the base 230. The flange 256 is insertable into the recess 238 of the base 230 to establish the first connection 222 that, to at least an extent, connects the cover 250 and the base 230 to one another. Prior to establishing the second connection 224, the flange 256 is adjustable/movable within the recess 238 when disposed therein (e.g., when the first connection 222 is established) such that the cover 250 and/or the base 230 are movable relative to one another to open/close the terminal 200B and/or the receptacle 220.

As generally illustrated in FIGS. 8 and 9, the biasing bodies 270, 270′ (e.g., a first biasing body 270 and a second biasing body 270′) are disposed in the receptacle 220 and engage, contact, and/or abut the exposed region 102A of the conductor body 102 to establish an electrical connection between the conductor 100, the terminal 200B, and/or the connector 20. The biasing bodies 270, 270′ each include a support frame 272, 272′ and one or more spring bars 274, 274′ connected to and supported by the support frame 272, 272′. The biasing body 270, 270′ and/or the support frame 272, 272′ has and/or forms a semi-annular and/or a tube-segment shape. The spring bars 274, 274′ extend in and/or substantially parallel to the longitudinal direction of the receptacle 220 and/or the conductor 100 between two (e.g., axial) ends and/or two opposing support members of the support frame 272, 272′. The spring bars 274, 274′ each include at least a portion and/or section that is arcuate-shaped. However, one or more of the biasing bodies 270, 270′, the support frames 272, 272′, and/or the spring bars 274, 274′ may have one or more other suitable configurations in other embodiments.

The first biasing body 270 is disposed on and connected to the U-shaped body 232 of the base 230 (e.g., via one or more welds 276 between the support frame 272 and the U-shaped body 232). The second biasing body 270′ is disposed on and connected to the U-shaped body 252 of the cover 250 (e.g., via one or more welds 276′ between the support frame 272′ and the U-shaped body 252). When the terminal 200B is arranged on the conductor 100 and/or the exposed region 102A of the conductor 100 is disposed in the receptacle 220 of the terminal 200B, the biasing bodies 270, 270′ engage, contact, and/or abut the exposed region 102A of the conductor body 102 via the spring bars 274, 274′. One or more of the spring bars 274, 274′ may be compressed and/or deformed (e.g., elastically) via the exposed region 102A of the conductor body 102, which may bias one or more spring bars 274, 274′ against the exposed region 102A of the conductor body 102 and increase and/or enhance the stability of the electrical connection between the conductor 100, the terminal 200B, and/or the connector 20.

As generally illustrated in FIGS. 8 and 9, the first connection 222 is defined and/or formed by one or more portions of the base 230 (e.g., the protrusion 236) and the cover 250 (e.g., the flange 256) that engage one another. The first connection 222, to at least an extent, releasably and adjustably connects the cover 250 and the base 230 to one another. The second connection 224 is a weld between and/or connecting one or more portions of the base 230 (e.g., the blade 234) and the cover 250 (e.g., the projection 254). One or more of the connections 222, 224 may alternatively be configured as a hinge, weld, fastener, or rivet, among other suitable configurations. When the cover 250 and the base 230 are connected by the first connection 222 and are not connected by the second connection 224 (e.g., prior to establishing the second connection 224), the cover 250 and/or the base 230 are adjustable and/or movable relative to one another such that (i) the base 230 and the cover 250 are detachable and/or separable and (ii) the terminal 200B and/or the receptacle 220 are openable and closable. Once the second connection 224 is established and/or provided, the first connection 222 and the second connection 224 connect (e.g., fix) the base 230 and the cover 250 together such that relative movement between the cover 250 and the base 230 is restricted, limited, and/or prevented and opening of the terminal 200B and/or the receptacle 220 is effectively prevented.

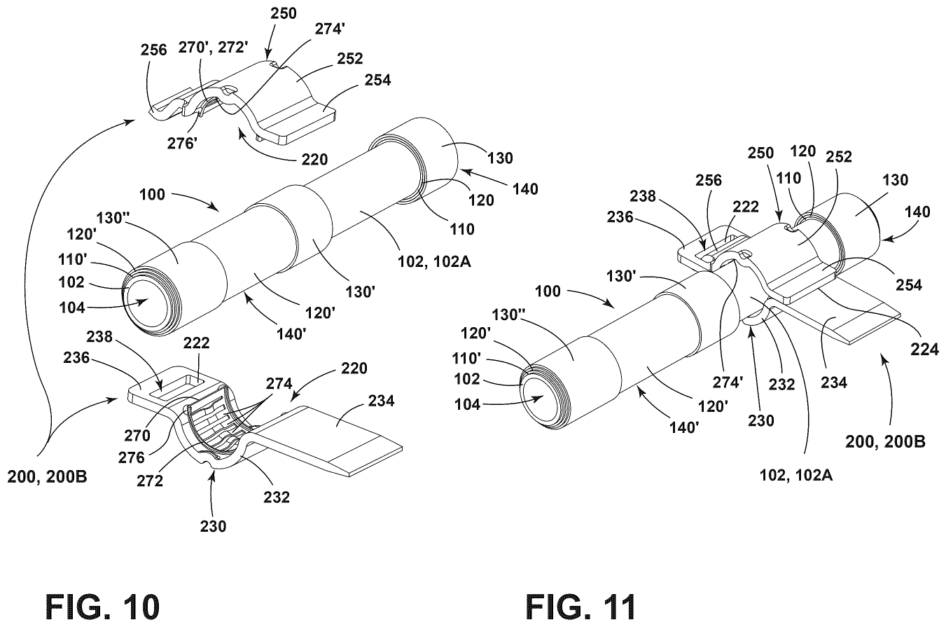

FIGS. 10 and 11 generally illustrate a method of attaching the terminal 200B to the conductor 100. To attach and/or connect the conductor 100 and the terminal 200B, the flange 256 of the cover 250 is inserted into the recess 238 of the base 230 to establish the first connection 222 that initially (e.g., prior to providing the second connection 224) releasably and adjustably connects the base 230 and the cover 250 to one another. Optionally, the cover 250 and/or the base 230 are then moved relative to one another to sufficiently open the terminal 200B and/or the receptacle 220 (e.g., if not already sufficiently open), and the terminal 200B is arranged on the exposed region 102A of the conductor body 102 and/or the exposed region 102A of the conductor body 102 is inserted into the receptacle 220. Alternatively, the cover 250 and/or the base 230 may be disposed on the exposed region 102A of the conductor body 102 prior to establishing the first connection 222. The cover 250 and/or the base 230 are then moved relative to one another to close the terminal 200B and/or the receptacle 220 and to contact the exposed region 102A of the conductor body 102 with the biasing bodies 270, 270′ (e.g., the spring bars 274, 274′), which in turn electrically connects the conductor 100 and the terminal 200B. When the conductor body 102 is disposed in the receptacle 220 and the terminal 200B and/or the receptacle 220 is closed, (i) the projection 254 of the cover 250 is disposed on, contacts, and/or abuts the blade 234 of the base 230, (ii) the flange 256 extends completely through the recess 238 of the protrusion 236 to an opposite side of the protrusion 236 and/or the base 230 and a free end of the flange 256 contacts, abuts, and/or presses against a surface of the protrusion 236 and/or the base 230 that faces away from the cover 250, and (iii) the biasing bodies 270, 270′ (e.g., one or more of the spring bars 274, 274′ thereof) are pressed and/or biased against the exposed region 102A of the conductor body 102 and may be at least partially (e.g., elastically and/or resiliently) deformed thereby. Subsequently, the projection 254 of the cover 250 and the blade 234 of the base 230 are connected, attached, and/or fixed to one another via the second connection 224 (e.g., via laser welding the projection 254 and the blade 234 together) as generally illustrated in FIG. 11 such that the terminal 200B and the conductor 100 are connected, attached, and/or secured to one another via the first connection 222 and the second connection 224.

As generally illustrated in FIGS. 1, 2, 5-7, and 12-17, the system 10 includes one or more header assemblies 300 (e.g., a header assembly 300A and/or a header assembly 300B) configured to physically connect the conductor 100 and the connector 20 and to facilitate electrically connecting the conductor 100 and the connector 20 (e.g., via aligning the blade 210, 234 of the terminal 200 with the connector conductor 22 when connecting the conductor 100 and the connector 20). The header assembly 300 is configured to receive, retain, and/or house at least a portion of the conductor 100 (e.g., the exposed region 102A of the conductor body 102), at least a portion of the terminal 200, and at least a portion of the connector 20. In other words, at least a portion of the conductor 100 (e.g., the exposed region 102A of the conductor body 102), at least a portion of the terminal 200, and at least a portion of the connector 20 are disposed in the header assembly 300. The header assembly 300 is disposed on, connected to, and/or mounted on the conductor 100 (e.g., the exposed region 102A of the conductor body 102). The header assembly 300 extends at least partially around at least a portion of the conductor 100 (e.g., the exposed region 102A of the conductor body 102) in a circumferential direction. The header assembly 300 includes a header 310 (e.g., a header 310A and/or a header 310B) and a cap 360 (e.g., a cap 360A and/or a cap 360B) that are connectable to one another.

As generally illustrated in FIGS. 1, 2, 5-7, and 12-17, the header 310 is configured to receive and/or retain at least a portion of the conductor 100 (e.g., the exposed region 102A of the conductor body 102), at least a portion of the terminal 200, and at least a portion of the connector 20.

As generally illustrated in FIGS. 5 and 12, the header 310 includes a support 312 that engages the conductor 100 and via which the header 310 is connected to the conductor 100. The header 310 and/or the support 312 includes and/or defines a depression 314 (e.g., an opening, recess, hole, aperture, etc.) configured to receive and/or retain at least a portion of the conductor 100 (e.g., the exposed region 102A of the conductor body 102) and at least a portion of the terminal 200. The support 312 includes one or more support surfaces 316 (e.g., header support surfaces) at least some of which at least partially define the depression 314. At least a portion of the conductor 100 and/or at least a portion of the terminal 200 may rest on and/or be supported by one or more support surfaces 316 when disposed in the header assembly 300, the header 310, and/or the depression 314. A length of the support 312 and/or the depression 314 (e.g., generally in the longitudinal direction of the conductor 100) substantially corresponds to (e.g., is equal to) a length of the exposed region 102A of the conductor 100 and/or a length of the cap 360 (see, e.g., FIGS. 1, 2, 6, 7, and 13-15). As such, when the exposed region 102A of the conductor 100 is disposed in the depression 314, the header 310 and/or the support 312 extends between and may contact the first protector 140 (e.g., the first inner insulator 110, the first shield 120, and the first outer insulator 130) and the second protector 140′ (e.g., the second inner insulator 110′, the second shield 120′, and the second outer insulator 130′).

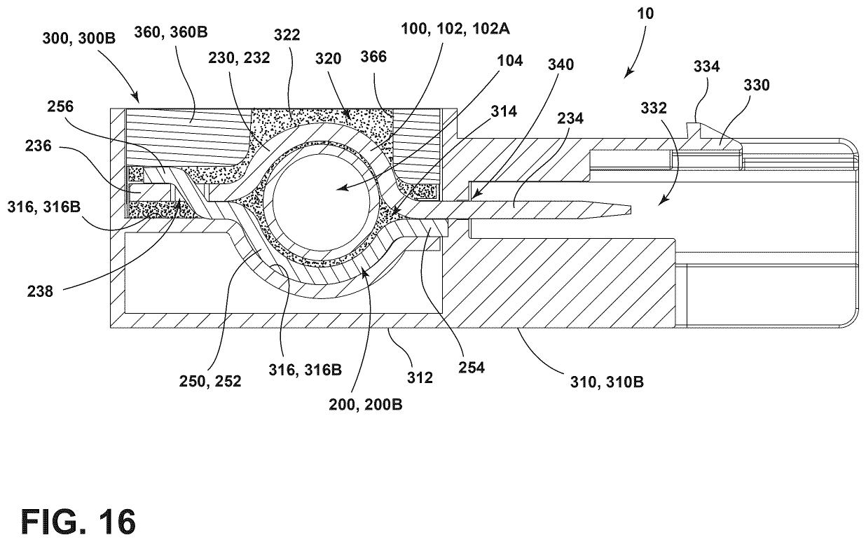

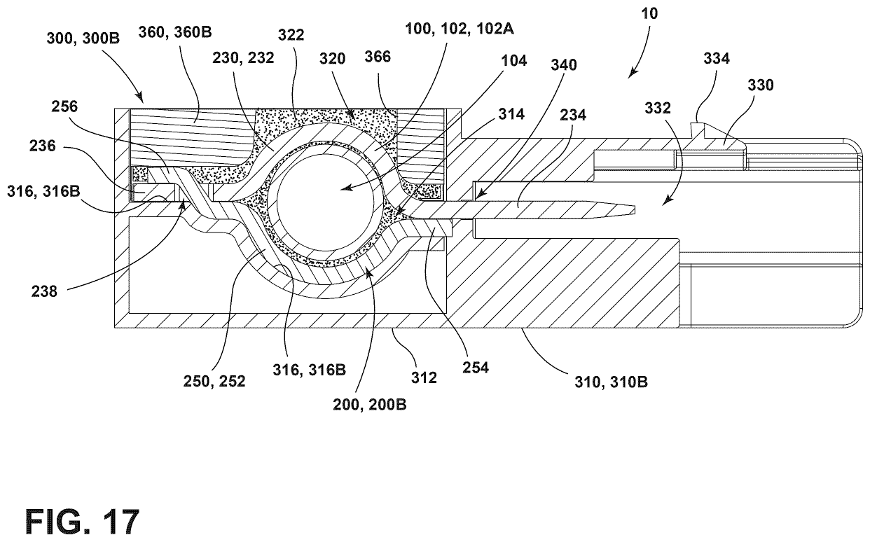

In some embodiments, such as the one generally depicted in FIG. 16, one or more support surfaces 316 (e.g., support surface 316B) of the support 312 contact and support at least a portion of the cover 250 (e.g., the U-shaped body 252, the projection 254, and/or the flange 256) of the terminal 200B, but do not contact and/or directly support the body 230 of the terminal 200B. In other embodiments, such as the one generally depicted in FIG. 17, one or more support surfaces 316 (e.g., support surface 316B) of the support 312 may include a step configuration that contacts and supports at least a portion of the cover 250 (e.g., the U-shaped body 252, the projection 254, and/or the flange 256) and at least a portion of the body 230 (e.g., the protrusion 236) of the terminal 200B.

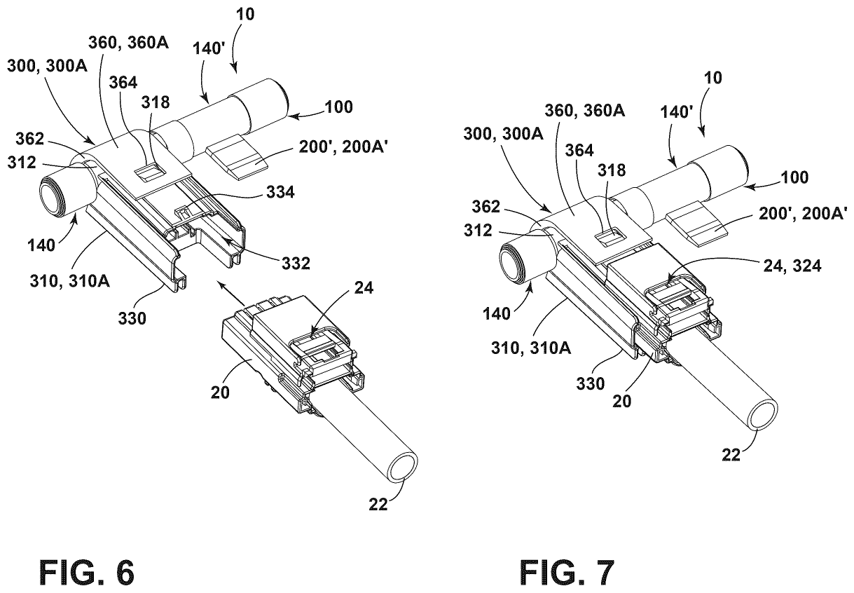

As generally illustrated in FIGS. 1, 2, 5-7, and 12-17, the header 310 includes an adapter 330 that engages the connector 20 and via which the header 310 and the header assembly 300 is physically connected to the connector 20. The adapter 330 is connected to (e.g., integrally formed with) the support 312 and projects therefrom transversely (e.g., perpendicularly or obliquely) and/or radially relative to the conductor 100. The adapter 330 defines an internal space 332 configured to receive at least a portion of the terminal 200 (e.g., at least a portion of the blade 210, 234) and at least a portion of the connector 20. The adapter 330 is connectable to the connector 20 via engagement of a fastener formation 334 of the adapter 330 and a complimentary fastener formation 24 of the connector 20, which secures the connector 20 within the internal space 332 and attaches the connector 20 to the header 310, the header assembly 300, and/or the conductor 100 (see, e.g., FIGS. 6, 7, 14, and 15).

As generally illustrated in FIGS. 16 and 17, the depression 314 of the support 312 and the internal space 332 of the adapter 330 are connected to one another via a passage 340, which is defined by the header 310 and/or one or more portions thereof. When the terminal 200 is disposed within the header assembly 300, the header 310, and/or the depression 314, the blade 210, 234 of the terminal 200 is disposed partially within the passage 340, extends through the passage 340, and projects out from the passage 340 into the internal space 332 of the adapter 330 such that the blade 210, 234 is engageable with and/or can be contacted by the connector conductor 22.

As generally illustrated in FIGS. 1, 2, 5-7, and 12-17, the cap 360 is connectable and/or securable to the header 310 (e.g., to the support 312 and/or to the adapter 330) to at least partially close and/or cover the depression 314 and, thereby, secure the conductor 100 and the terminal 200 in the depression 314 of the support 312. This in turn also connects and/or attaches the header 310 and/or the header assembly 300 to the conductor 100 and the terminal 200. The cap 360 may be disposed at least partially within the header 310 and/or at least partially outside of the header 310. Additionally and/or alternatively, the cap 360 may be releasably connected to the header 310 or non-releasably connected to the header 310. For example, in the embodiment generally illustrated in FIGS. 1 and 5-7, the cap 360A is disposed (e.g., completely) outside of the header 310A and is releasably connected to the header 310A. In other embodiments, such as the ones generally illustrated in FIGS. 2 and 12-17, the cap 360B is disposed (e.g., completely) in the header 310B and is non-releasably connected to the header 310B (e.g., via a potting material 322). When connected to the header 310, the cap 360 at least partially closes the depression 314. The cap 360 includes one or more support surfaces 362 (e.g., cap support surfaces) one or more of which may contact and/or rest on at least a portion of the conductor 100 and/or at least a portion of the terminal 200 when the cap 360 is connected to the header 310 (see, e.g., FIGS. 5 and 12), which may support, secure, and/or stabilize the conductor 100 in the depression 314. A length of the cap 360 (e.g., generally in the longitudinal direction of the conductor 100) substantially corresponds to (e.g., is equal to) the length of the exposed region 102A of the conductor 100 and/or the length of the support 312 (see, e.g., FIGS. 1, 2, 6, 7, and 13-15). As such, when the header assembly 300 is disposed on and/or attached to the conductor 100, the header assembly 300, the header 310, the support 312, and/or the cap 360 extend between and may contact the first protector 140 (e.g., the first inner insulator 110, the first shield 120, and the first outer insulator 130) and the second protector 140′ (e.g., the second inner insulator 110′, the second shield 120′, and the second outer insulator 130′).

FIGS. 5-7 generally illustrate a method of attaching a connector 20 to a conductor 100 with and/or utilizing a system 10 including the terminal 200A and the header assembly 300A, such as the system 10 of FIG. 1. As shown in FIG. 5, the header assembly 300A is connected, attached, and/or mounted to the conductor 100 and/or the terminal 200A. To connect the header assembly 300A to the conductor 100 and/or the terminal 200A, the exposed region 102A of the conductor 100 is disposed in the depression 314 such that the blade 210 of the terminal 200A projects through the passage 340 into the internal space 332 of the adapter 330. The cap 360A is then disposed on the header 310A and adjusted to at least partially close and/or cover the depression 314 and to engage a latching formation 364 of the cap 360A (e.g., a recess and/or depression) and a complimentary latching formation 318 of the header 310A (e.g., a latching nose and/or projection disposed on the adapter 330), which releasably connects the cap 360A and the header 310A as generally shown in FIGS. 1, 6, and 7. In this manner, the cap 360A secures the conductor 100 and the terminal 200A in the depression 314 of the support 312 and connects the header 310A and/or the header assembly 300A to the conductor 100 and the terminal 200A. At least a portion of the connector 20 and/or the connector conductor 22 is then inserted into the internal space 332 of the adapter 330 (e.g., in a transverse and/or radial direction relative to the conductor 100) as generally shown in FIG. 6 to engage the fastener formation 24 of the connector 20 with the complimentary fastener formation 334 of the header assembly 300A and to engage the connector conductor 22 with the terminal 200A. The engagement of the fastener formations 24, 334 releasably connects the connector 20 to the header assembly 300A as depicted in FIG. 7, which physically connects the connector 20 to the conductor 100. The engagement of the connector conductor 22 and the terminal 200A electrically connects the connector 20 and the conductor 100.

FIGS. 12-15 generally illustrate a method of attaching a connector 20 to a conductor 100 with and/or utilizing a system 10 including the terminal 200B and the header assembly 300B, such as the system 10 of FIG. 2. As shown in FIG. 12, the header assembly 300B is connected, attached, and/or mounted to the conductor 100 and/or the terminal 200B.

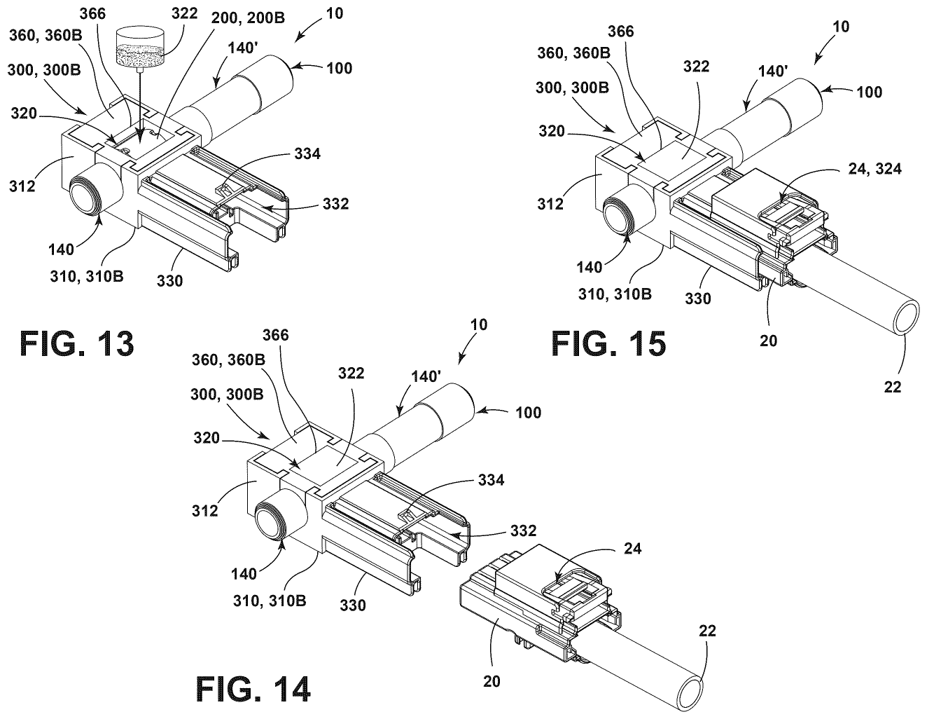

To connect the header assembly 300 to the conductor 100 and/or the terminal 200B, the exposed region 102A of the conductor 100 is disposed in the depression 314 and contacts (e.g., rests on) one or more support surfaces 316 (e.g., support surfaces 316A) of the support 312 such that the terminal 200B (e.g., the cover 250, U-shaped body 252, projection 254, flange 256, base 230, and/or protrusion 236) contacts and/or rests on one or more support surfaces 316 (e.g., support surfaces 316B) of the support 312 and the blade 234 of the terminal 200B projects through the passage 340 into the internal space 332 of the adapter 330. The cap 360B is inserted (e.g., generally in a radial direction of the conductor 100) into a cavity 320 of the support 312, which opens in the same direction as the depression 314, such that the cap 360B is disposed (e.g., completely) within the support 312 and/or the header 310B and partially closes the depression 314, the cavity 320, and/or the support 312 as generally shown in FIG. 13. In this manner, the cap 360B secures the conductor 100 and the terminal 200B in the depression 314 of the support 312 and connects the header 310B and/or the header assembly 300B to the conductor 100 and the terminal 200B. Potting material 322 is then disposed in the depression 314, the cavity 320, and/or the passage 340, such as via conveying and/or injecting the potting material 322 through an aperture 366 in the cap 360B as generally depicted in FIG. 13. The potting material 322 may substantially fill an entirety of the remaining space within the depression 314, the cavity 320, the passage 340, and/or the aperture 366 as generally illustrated in FIGS. 16 and 17. The potting material 322 contacts and/or adheres to the conductor 100 (e.g., the exposed region 102A of the conductor body 102), the terminal 200B, the header 310B (e.g., the support 312 and/or the adapter 330), and/or the cap 360B to non-releasably connect (i) the header 310B and the cap 360B and (ii) the conductor 100, the terminal 200B, and the header assembly 300B. The potting material 322 also restricts, limits, and/or prevents galvanic corrosion for occurring between the conductor 100 (e.g., the conductor body 102) and the terminal 200B within the header assembly 300B. At least a portion of the connector 20 and/or the connector conductor 22 is then inserted into the internal space 332 of the adapter 330 (e.g., in a transverse and/or radial direction relative to the conductor 100) as generally shown in FIG. 14 to engage the fastener formation 24 of the connector 20 with the complimentary fastener formation 334 of the header assembly 300B and to engage the connector conductor 22 with the terminal 200B. The engagement of the fastener formations 24, 334 releasably connects the connector 20 to the header assembly 300B as depicted in FIG. 15, which physically connects the connector 20 to the conductor 100. The engagement of the connector conductor 22 and the terminal 200B electrically connects the connector 20 and the conductor 100.

While embodiments are generally illustrated with the system 10 including a single first terminal 200, a single second terminal 200′, and/or a single header assembly 300, embodiments of the system 10 may include several first terminals 200, several second terminals 200′, and/or several header assemblies 300. Similarly, while embodiments are generally illustrated with the system 10 including a single terminal configuration 200A, 200B and a single header assembly configuration 300A, 300B, embodiments of the system 10 may include several terminals 200, 200′ with different configurations and/or several header assemblies 300 with different configurations, which may be utilized with one another in a variety of different combinations. For example, a system 10 may include a conductor 100, a terminal 200A disposed at least partially in a header assembly 300A, a terminal 200B disposed at least partially in a header assembly 300B, another terminal 200A disposed at least partially in another header assembly 300B, and another terminal 200B disposed at least partially in another header assembly 300A. Additionally and/or alternatively, a header assembly 300, 300A, 300B may be utilized in conjunction with a second terminal 200′ in a similar manner to a first terminal 200, 200A, 200B described above.

The disclosure includes, without limitation, the following embodiments:
1. A system for attaching an electrical connector to a conductor, comprising a header assembly connectable to said conductor and releasably connectable to said connector; a terminal disposed in and connected to the header assembly, the terminal connectable to said conductor such that the terminal projects radially from said conductor; wherein, when the header assembly is connected to said conductor and to said connector, (i) the header assembly physically connects said connector and said conductor and (ii) the terminal engages a connector conductor of said connector electrically connecting said conductor and said connector.
2. The system according to embodiment 1, wherein the header assembly includes a header and a cap; the header includes a depression, the depression receiving at least a portion of the terminal and at least a portion of said conductor; the cap is connectable to the header and, when connected to the header, at least partially closes the depression; and the header assembly is connectable to said conductor via connecting the cap to the header.
3. The system according to any of the preceding embodiments, wherein the header includes: a support via which the header is connectable to said conductor; and an adapter via which the header is connectable to said connector.
4. The system according to any of the preceding embodiments, wherein: the support defines the depression; and the adapter is connected to and projects from the support transversely relative to said conductor.
5. The system according to any of the preceding embodiments, wherein the support includes a support surface that at least partially defines the depression and that supports at least a portion of said conductor.
6. The system according to any of the preceding embodiments, wherein the cap includes a support surface that at least one of contacts and rests on at least a portion of said conductor.
7. The system according to any of the preceding embodiments, wherein the adapter defines an internal space that receives at least a portion of said connector.
8. The system according to any of the preceding embodiments, wherein: the header includes a passage connecting the depression of the header and the internal space of the adapter; and the terminal is disposed at least partially in the passage and projects from the passage into the internal space of the adapter.
9. The system according to any of the preceding embodiments, wherein: the adapter includes a fastener formation; and the header assembly is connectable to said connector via engagement of the fastener formation and a complementary fastener formation of said connector.
10. The system according to any of the preceding embodiments, wherein: the cap includes a latching formation; the header includes a complimentary latching formation; and the cap is releasably connectable to the header via engagement of the latching formation of the cap and the complementary latching formation of the header.
11. The system according to any of the preceding embodiments, wherein: the terminal includes a blade extending transversely relative to said conductor; the blade includes a first portion composed of aluminum and a second portion composed of copper.
12. The system according to any of the preceding embodiments, wherein: the terminal is connectable to said conductor via welding the first portion of the blade to said conductor; and the second portion of the blade is connected to the first portion of the blade and defines a free end of the blade.
13. The system according to any of the preceding embodiments, wherein the terminal includes: a base; a cover connectable to the base; and a receptacle defined by and between the cover and the base, the receptacle receiving at least a portion of said conductor.
14. The system according to any of the preceding embodiments, wherein: the base includes a protrusion defining a recess; the cover includes a flange insertable into the recess; and a first connection at least partially connecting the base and the cover is establishable via inserting the flange into the recess.
15. The system according to any of the preceding embodiments, wherein: the base includes a blade; the cover includes a projection; and a second connection at least partially connecting the base and the cover is establishable via connecting the projection and the blade.
16. The system according to any of the preceding embodiments, wherein, prior to establishing the second connection, the flange is adjustable within the recess such that the base and the cover are movable relative to one another to one of open and close the receptacle.
17. The system according to any of the preceding embodiments, wherein: the base includes a U-shaped body, a blade, and a protrusion, the blade and the protrusion connected to and projecting from opposite ends of the U-shaped body of the base; and the cover includes a U-shaped body, a projection, and a flange, the projection and the flange connected to and projecting from opposite ends of the U-shaped body of the cover.
18. The system according to any of the preceding embodiments, wherein: the terminal includes a plurality of biasing bodies each including a support frame and at least one spring bar connected to and supported by the support frame, the at least one spring bar contactable via said conductor; a first biasing body of the plurality of biasing bodies is connected to the U-shaped body of the base; and a second biasing body of the plurality of biasing bodies is connected to the U-shaped body of the cover.
19. The system according to any of the preceding embodiments, wherein: the header defines the depression and a cavity; the depression and the cavity open in the same direction; and the cap is disposable within the cavity and, when disposed within the cavity, at least partially closes the depression and the cavity.
20. The system according to any of the preceding embodiments, wherein the cap includes an aperture via which potting material is injectable into at least one of the cavity and the depression to non-releasably connect (i) the header and the cap and (ii) the header assembly, the terminal, and said conductor.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A system for attaching an electrical connector to a conductor, comprising:
a header assembly connectable to said conductor and releasably connectable to said connector;
a terminal disposed in and connected to the header assembly, the terminal connectable to said conductor such that the terminal projects radially from said conductor;
wherein, when the header assembly is connected to said conductor and to said connector, (i) the header assembly physically connects said connector and said conductor and (ii) the terminal engages a connector conductor of said connector electrically connecting said conductor and said connector.

2. The system according to claim 1, wherein:
the header assembly includes a header and a cap;
the header includes a depression, the depression receiving at least a portion of the terminal and at least a portion of said conductor;
the cap is connectable to the header and, when connected to the header, at least partially closes the depression; and
the header assembly is connectable to said conductor via connecting the cap to the header.

3. The system according to claim 2, wherein the header includes:
a support via which the header is connectable to said conductor; and
an adapter via which the header is connectable to said connector.

4. The system according to claim 3, wherein:
the support defines the depression; and
the adapter is connected to and projects from the support transversely relative to said conductor.

5. The system according to claim 4, wherein the support includes a support surface that at least partially defines the depression and that supports at least a portion of said conductor.

6. The system according to claim 4, wherein the cap includes a support surface that at least one of contacts and rests on at least a portion of said conductor.

7. The system according to claim 4, wherein the adapter defines an internal space that receives at least a portion of said connector.

8. The system according to claim 7, wherein:
the header includes a passage connecting the depression of the header and the internal space of the adapter; and
the terminal is disposed at least partially in the passage and projects from the passage into the internal space of the adapter.

9. The system according to claim 3, wherein:
the adapter includes a fastener formation; and
the header assembly is connectable to said connector via engagement of the fastener formation and a complementary fastener formation of said connector.

10. The system according to claim 2, wherein:
the cap includes a latching formation;
the header includes a complimentary latching formation; and
the cap is releasably connectable to the header via engagement of the latching formation of the cap and the complementary latching formation of the header.

11. The system according to claim 1, wherein:
the terminal includes a blade extending transversely relative to said conductor; and
the blade includes a first portion composed of aluminum and a second portion composed of copper.

12. The system according to claim 11, wherein:
the terminal is connectable to said conductor via welding the first portion of the blade to said conductor; and
the second portion of the blade is connected to the first portion of the blade and defines a free end of the blade.

13. The system according to claim 1, wherein the terminal includes:
a base;
a cover connectable to the base; and
a receptacle defined by and between the cover and the base, the receptacle receiving at least a portion of said conductor.

14. The system according to claim 13, wherein:
the base includes a protrusion defining a recess;
the cover includes a flange insertable into the recess; and
a first connection at least partially connecting the base and the cover is establishable via inserting the flange into the recess.

15. The system according to claim 14, wherein:
the base includes a blade;
the cover includes a projection; and
a second connection at least partially connecting the base and the cover is establishable via connecting the projection and the blade.

16. The system according to claim 15, wherein, prior to establishing the second connection, the flange is adjustable within the recess such that the base and the cover are movable relative to one another to one of open and close the receptacle.

17. The system according to claim 13, wherein:
the base includes a U-shaped body, a blade, and a protrusion, the blade and the protrusion connected to and projecting from opposite ends of the U-shaped body of the base; and
the cover includes a U-shaped body, a projection, and a flange, the projection and the flange connected to and projecting from opposite ends of the U-shaped body of the cover.

18. The system according to claim 17, wherein:
the terminal includes a plurality of biasing bodies each including a support frame and at least one spring bar connected to and supported by the support frame, the at least one spring bar contactable via said conductor;
a first biasing body of the plurality of biasing bodies is connected to the U-shaped body of the base; and
a second biasing body of the plurality of biasing bodies is connected to the U-shaped body of the cover.

19. The system according to claim 2, wherein:
the header defines the depression and a cavity;
the depression and the cavity open in the same direction; and
the cap is disposable within the cavity and, when disposed within the cavity, at least partially closes the depression and the cavity.

20. The system according to claim 19, wherein the cap includes an aperture via which potting material is injectable into at least one of the cavity and the depression to non-releasably connect (i) the header and the cap and (ii) the header assembly, the terminal, and said conductor.
